(19) United States
(12) Patent Application Publication
(10) Pub. No.: US 2009/0081921 A1
(43) Pub. Date: Mar. 26, 2009

(54) Hide me pal

(76) Inventor: Shirley Lucia Urueta, Rutherford, NJ (US)

Correspondence Address: SHIRLEY URUETA, 1st Fl, 94 Feronia Way, Rutherford, NJ, 07070, US

(21) Appl. No.: 12/283,401

(22) Filed: Mar. 1, 2007

(51) Int. Cl. A63H 3/02; A61J 11/00

(52) U.S. Cl. 446/369; 606/236

(57) ABSTRACT

A small stuffed toy in the shape of a animal, such as a bunny, bear etc with a Pacifier pouch. A strap extending from the pouch with a Velcro that is used to attach a pacifier inside the body of the toy, (pacifier not included). A second shorter strap extending from the head Portion is used to provide a convenient anchor point for securing the toy to a high chair or stroller etc.

### FIELD OF THE INVENTION

This invention relates generally to a stuffed toy which may take the form of an animal or doll or other geometric shape and which includes a pouch hidden in the back of the stuffed toy to hide a pacifier. Also includes a strap that will attach a pacifier to keep clean and safe from loss.

### SUMMARY OF INVENTION

The preferred form for an infant's toy or small child constructed in an accordance with the present invention calls for the stuffed toy to include a readily deformable fabric envelope having at least one hidden pouch, and including a filler inside the envelope to provide the toy a variable three dimensional shape and configuration such as a typical stuffed toy or doll which is relatively soft to the touch and easily handled by a small child. The means of securing the pacifier is a strap attached to the pouch inside the stuffed toy, Which can be in the form of any geometric shape such as a ball or square.

### BRIEF DESCRIPTION OF THE DRAWING

The figure is a three dimensional view illustrating a stuffed toy bunny constructed in accordance with the present invention and having a pouch to hold a pacifier and a strap to attached the pacifier inside the body of the stuffed toy.

### DETAILED DESCRIPTION

Turning to the drawing in greater detail, a stuffed toy (A) is provided with a pouch (B) located inside the toy and a strap (C) to hold a pacifier in place. This toy can be picked up and held by an infant or toddler and can be attached to a crib, playpen or stroller by a the smaller strap extending from the head portion (D) and a link ring or Velcro can be used.

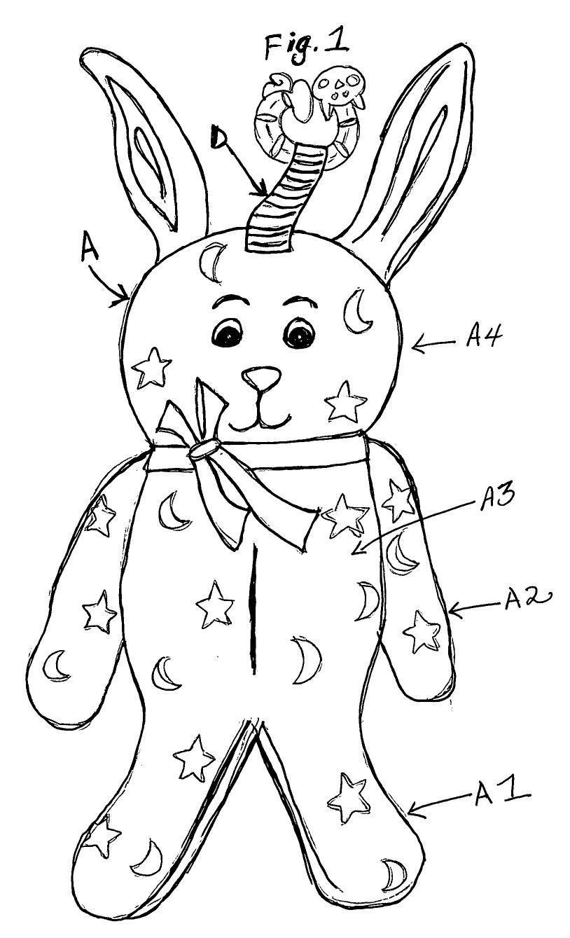

The stuffed toy (A) preferably has two legs (A1) and two Arms (A2) connected to a soft pliable body portion (A3). A projecting portion (A4) of the body portion defines a head for stuffed toy. (See FIG. 1)

The toy is large enough to fit a pacifier located in the back of the stuffed toy and can be closed by Velcro, zipper, lace snaps etc. to keep pacifier hidden and clean.

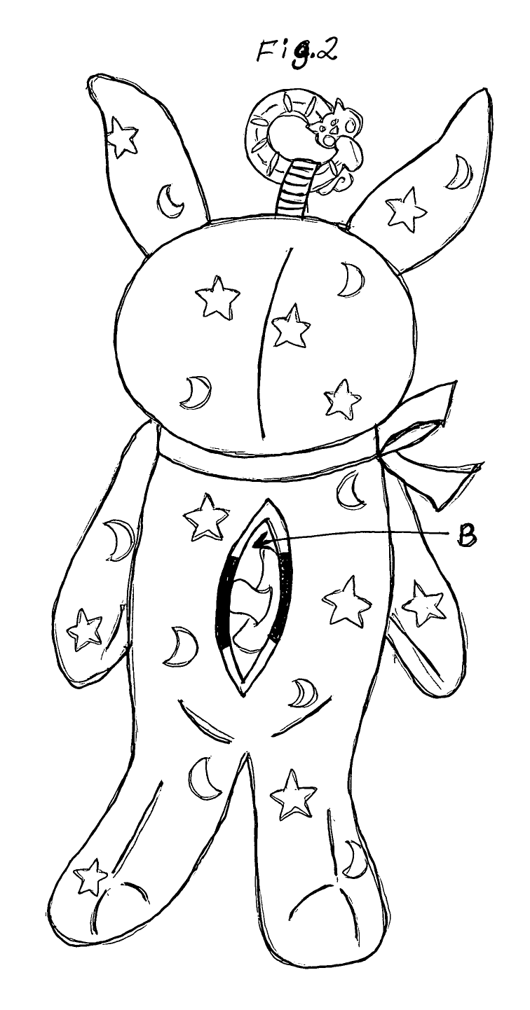

The pouch (B) can be made of vinyl material or any other fabric like cotton or organza that can be easily cleaned by washing or wiping and can be shape of a square or rectangular. (See FIG. 2)

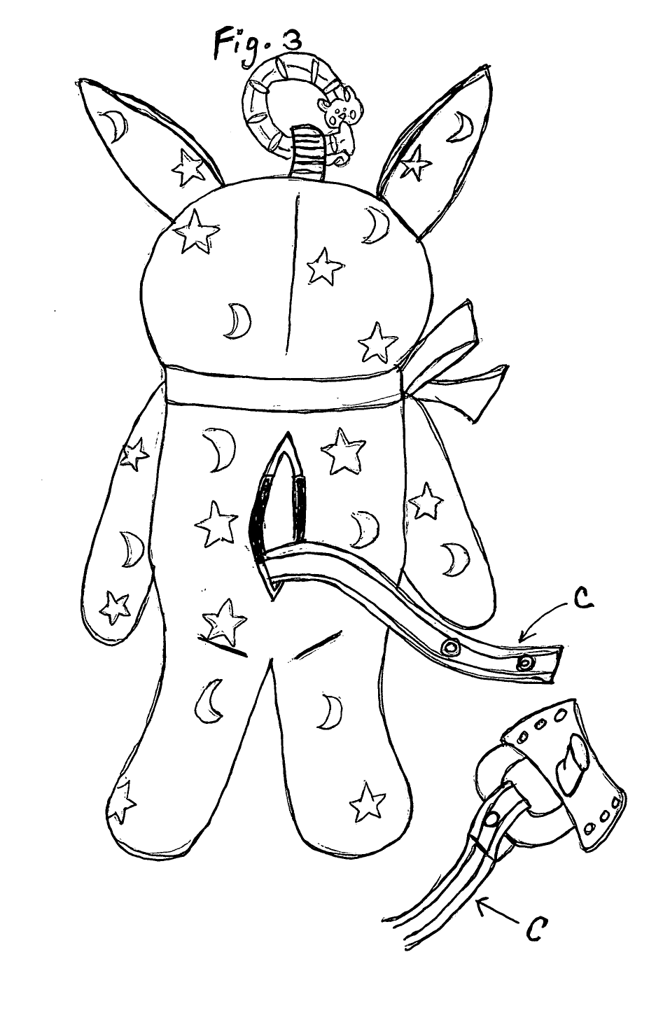

The strap (C) can be lace material or vinyl material located inside the pouch and is no longer than 6-8 inches with Velcro or snaps at the end of the strap to attach a pacifier. (See FIG. 3)

The shorter strap (D) on the head portion can be lace or vinyl material secured on top by sewing into the head portion, no longer than 2-3 inches with Velcro at the end to the crib, playpen or stroller etc. to keep pacifier safe and clean. (See FIG. 1)

What is claimed is:

1. An stuffed toy and pouch comprising of:
A. A stuffed toy including a readily deformable fabric envelope defining at least one hidden pouch portion, and said stuffed toy including filler inside giving the toy a three dimensional shape and configuration.
B. A pouch attached inside the said stuffed toy, where in said pouch includes a strap with Velcro or snaps at the end portion to attach a pacifier.

2. The stuffed toy and pouch of claim 1. Said envelope having the shape of an animal with a projecting portion having the shape of the head.

3. The toy and pouch of claim 2, wherein said envelope further defines a plurality of legs and arms.

4. The toy and pouch of claim 2, wherein the means for the shorter strap be fixed securely to the projecting head portion.

5. The stuffed toy and pouch of claim 1, wherein the back surface having a lateral opening allowing access to the interior comprising of a fabric pouch, said lateral opening having two sides lined with mutually engage able means of attachment on opposing parts adapted to engage each other held together by zipper, Velcro or lace tie. Further defined as being securely affixed directly into the toy member by stitching or sewing in place and formed by soft deformable and pliable material.

6. The stuffed toy and pouch in claim 1, said envelope having a geometric shape and of a three dimensional shape.

7. A combined pouch and toy assembly constructed for use by infants and comprising of:
(a) A stuffed toy made out of fabric or other material including filler inside said envelope to provide said toy with a variable three dimensional shape and configuration a pacifier can be attached to said stuffed toy by way of said projecting portion.
(b) Said extension member back surface having a lateral opening allowing access to the interior comprising of a fabric pouch said lateral opening having two sides lined with mutually engage able means of attachment on opposing parts adapted to engage each other.
(c) Said extension member back surface additionally having a strap stitched directly into toy member to provide secure affixation thereto comprising of mutually engaging releasable adhesive means and the area of engagement of said strap, for the purpose of attaching the said pacifier consisting of snap, hook, hook and loop fastener or Velcro.
(d) An extension member attached at one end to the head of the body of the toy and extending outwardly away from said body to a distal end. Said extension member having a strap stitched directly into the toy member to provide secure affixation thereto comprising of mutually engaging releasable adhesive means and the area of the engagements of said strap with a snap, hook, hook and loop fastener, or Velcro.
